(19) United States
(12) Patent Application Publication
(10) Pub. No.: US 2016/0213172 A1
(43) Pub. Date: Jul. 28, 2016

(54) SHELF FACING DEVICE

(71) Applicant: William E. Christoffersen, Bend, OR (US)

(72) Inventor: William E. Christoffersen, Bend, OR (US)

(21) Appl. No.: 14/604,436

(22) Filed: Jan. 23, 2015

(51) Int. Cl. A47F 13/06; B25J 1/04; B65D 25/22; A47F 5/00

(52) U.S. Cl. CPC A47F 13/06; A47F 5/0043; B25J 1/04; B65D 25/22

(57) ABSTRACT

A shelf facing device has an elongate member or members adapted to reach beyond the rear-most item on a shelf, and interact with the item to allow the item to be pulled forwardly on the shelf. A variety of configurations for engaging with the item are shown. The items or packaging/containers thereof may be configured to have features or portions for enhanced engagement by a shelf facing device.

### BACKGROUND

This disclosure relates to arranging items on shelves, and more particularly to an improved apparatus and method for facing shelves.

There is a need for a device or devices that will automate or speed the process of “facing” store shelves. After a retail store shelf has been fully stocked and customers or agents have removed some of the products from the front of the shelf, more of those products must be added or restocked. As a regular routine until the time when such additional products are added, existing product must be moved to the front of the shelf, the process known as “facing.”

This facing of the shelf makes the product easily available to the customer as well as making it easier to find.

Many hours are expended each week or each day revising the shelves in a store in order to make the products more salable. Thus, the cost of facing is substantial.

It is desirable to keep shelves loaded as much as possible vertically and horizontally so that the maximum number of goods may be presented to customers at any given store. Therefore, it is most efficient to keep very little or no space between the various rows on a shelf. Similarly, it is most efficient to maintain a minimal amount of space between the top of the product and the shelf above, headroom. This leaves little space for staff to reach into the shelves for facing. Therefore, a device to be utilized for the process of facing must accommodate these considerations to a maximum degree and can often require different device configurations to optimize the process for different products.

### SUMMARY

In accordance with the disclosure, shelf facing devices are provided for assisting in bringing products forward on a shelf.

Accordingly, it is an advantage of the present disclosure to provide an improved shelf facing device.

It is a further advantage of the present disclosure to provide improved shelf facing devices and methods.

It is yet another advantage of the present disclosure to provide an improved system for facing shelves and rotating products.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings.

### BRIEF DESCRIPTION OF THE DRAWINGS

FIG. 1 is a perspective view illustrating a first embodiment of a shelf facing device in accordance with the present disclosure;

FIG. 2 is a plan view of the shelf facing device of FIG. 1;

FIG. 3 is a side view of the shelf facing device of FIG. 1;

FIG. 4 is a perspective view of an alternative embodiment of a shelf facing device for moving objects with flat tops such as cans;

FIG. 5 is a perspective view of an alternative embodiment of a shelf facing device with adjustable sidebars for accommodating objects of differing widths;

FIG. 6 is a perspective view of an alternative embodiment of a shelf facing device with an operable hook or tab, which is especially useful for facing rectangular objects;

FIG. 7 is a perspective view of an alternative embodiment of a shelf facing device with multiple hooks or tabs which is especially useful for round objects such as cans, but equally useful for rectangular objects;

FIG. 8 is a side partially cut away view of a shelf facing device with an alternative method of activating a hook or tab at the back end;

FIG. 9 is a perspective view of an alternative embodiment of a shelf facing device especially adapted for use for bottles with a neck;

FIG. 10 is a perspective view of an alternative embodiment of a shelf facing device having two rigid ell-shaped sidebars that are pulled together when activated by the operator;

FIG. 11 is a perspective view illustrating the configuration of a flap or door, a tube containing a push/pull rod, and two sidebars of the device of FIG. 10;

FIG. 12 is a view illustrating the positioning and method of capturing objects having a cap area larger than the neck area using the device of FIG. 10;

FIG. 13 illustrates a second manner of configuring a flap or door designed to capture the objects to be moved with the device of FIG. 10;

FIG. 14 illustrates an alternative method of gripping target objects by means of applying pressure onto the object cap area;

FIG. 15 is a perspective view of an alternative embodiment of a shelf facing device having a rotating set of shafts;

FIG. 16 illustrates the device depicted in FIG. 15 from a back end view showing the two fully executed rod positions, horizontal and vertical;

FIG. 17 illustrates the device depicted in FIGS. 15 and 16 from a side view in the vertical fully executed position;

FIG. 18 is a perspective view of an alternative embodiment of a shelf facing device of the FIG. 15 configuration employing with variable width and optional multiple rotating shafts to be inserted along each side of the objects to be moved;

FIGS. 19A and 19B illustrate the device depicted in FIG. 18 from a back end view, showing the two fully executed positions of the rod positions, horizontal (FIG. 19A) and vertical (FIG. 19B) with an alternative vertical position demonstrated in FIG. 19B;

FIG. 20 is a perspective view of an alternative embodiment of a shelf facing device of the FIG. 18 an ell hook at the end of the rod remains fixed in the horizontal position;

FIG. 21 is a perspective view of an alternative embodiment of a shelf facing device designed to move bottles, jugs and similar shaped objects that have a loop type of handle;

FIG. 22 is a top view of an alternative embodiment of a shelf facing device illustrating a design of the gripping device located at the end of the facing device depicted in FIG. 21;

FIGS. 23A and 23B illustrate an alternative design to the gripping device illustrated in FIG. 21, wherein FIG. 23B is a magnified close up of a portion of FIG. 23A;

FIGS. 24A and 24B are perspective views of an embodiment of a facing device employing an alternative gripping configuration with multiple rods that move apart from each other in order to grip, with FIG. 24B being a magnified close up of a portion of FIG. 24A;

FIGS. 25A and 25B are perspective views of an embodiment of a facing device designed to grip objects similar to that of a pair of tongs and tongs in reverse, with FIG. 25B being a magnified close up of a portion of FIG. 25A;

FIG. 26 illustrates a form of closed loop hydraulic control for a facing device;

FIG. 27 is a perspective view of an economical tubular shaped attachment device for affixing to a product or product container for the purpose of better accommodating shelf facing;

FIG. 28 is a perspective view of an alternative economical cardstock attachment device to affix to the product or product container for the purpose of better accommodating shelf facing;

FIG. 29 is a perspective view of an economical spherical shaped device to be either affixed to the product or product container so that a shelf facing can be better accomplished;

FIG. 30 is a perspective view of a product packaging configuration employing a built-in insertion point to accommodate a facing device;

FIG. 31 is a side view of a shelf extension device;

FIG. 32 is a perspective assembly view of a shelf extension device; and

FIG. 33 is a perspective view of a cart for multiple shelf facing device storage with integrated shelf extension device.

### DETAILED DESCRIPTION

The system according to a preferred embodiment of the present disclosure comprises a device for easily reaching to the back of a shelf full of items to pull items forward on the shelf.

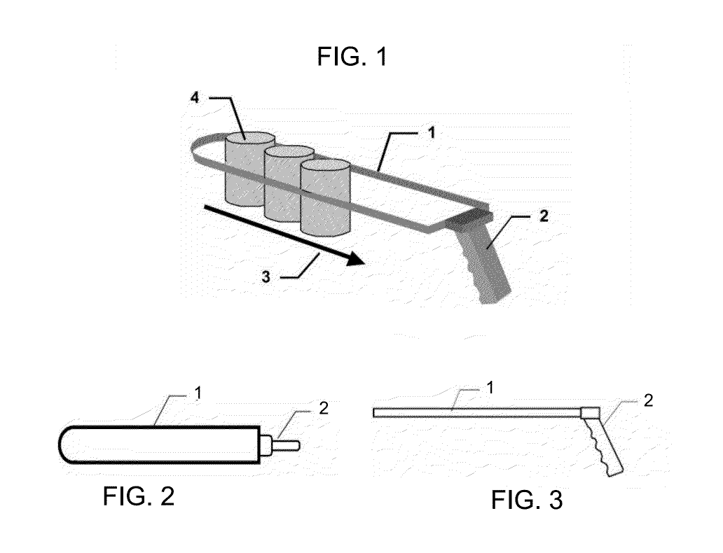

FIG. 1, a perspective view illustrating a first embodiment of a shelf facing device, illustrates how product might be moved forward in a space having only minimal headroom utilizing the concept of the device in its simplest form. A product engaging portion 1, which may comprise a rigid thin metal or other material, either flat material as illustrated or rod material, extends horizontally from a handle 2 forming a loop-like configuration having sufficient space between lateral edges of the loop to fit over the top of the products. The rear most end of the handle engaging portion forms a closed end or loop so as to engage with the rear of any product when pulled forwardly in the direction 3 toward the shelf face, thereby pulling the products 4 toward the shelf face.

FIGS. 2 and 3 are plan and side views of the shelf facing device of FIG. 1, illustrating more fully how a thin rod or strip of strong material such as metal is formed into an enclosure that will fit the product being faced onto the shelf. A thin material in the horizontal direction allows shelf configuration with minimal distance between rows of product on the shelf. A thin material in the vertical direction allows minimal headroom required for reaching back into the row.

In use, the device is inserted into the shelf above the product and lowered to contain the product within the interior of loop 1. Thus, the product is captured. Then the operator of the facing device can pull the product toward the front of the shelf.

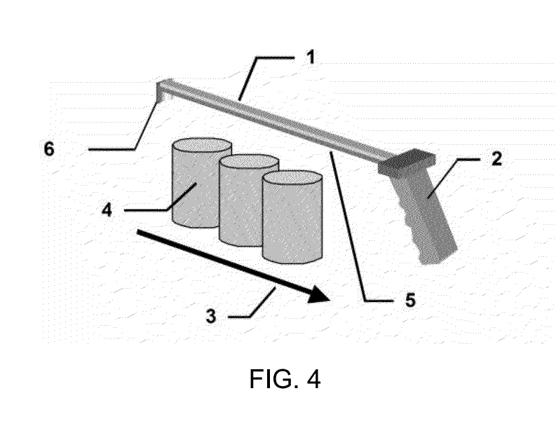

A corresponding device can be utilized that will simply reach back and hook the product. However, it will be noticed that often the product will not maintain a straight line front-to-back because of the forces being exerted. Nonetheless, such a device may be utilized where product on either side contains the row being moved forward. Still, a better method can be found. FIG. 4, a perspective view of an alternative embodiment of a shelf facing device for moving objects with flat tops such as cans, illustrates how such a hook device may be combined with a type of material that will minimally hold objects from moving sideways. An elongate rigid tube 1 extends backwardly from handle 2, the tube comprising metal or other strong material, with a strip of soft rubber-like material 5 on the face of the tube that contacts the products to provide friction with the product being moved. This material may be simple rubber, sticky material, soft material or more elaborate material with nubs, anything that will hook or provide a slight amount of friction. An optional tab or hook 6 may be positioned at the end of the tube 1 farthest from the handle 2, enabling hooking against a back face of the product 4 so that the product may be faced in direction 3. Tab or hook 6 may be a fixed configuration or may be operable.

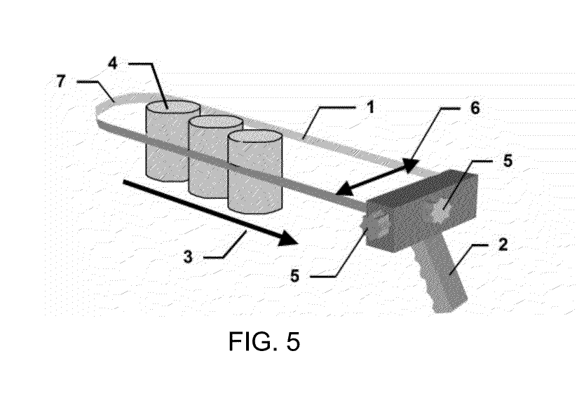

Referring now to FIG. 5, a perspective view of an alternative embodiment of a shelf facing device with adjustable sidebars for accommodating objects of differing widths, a mechanized functionality has been added to accommodate a variety of product widths. The side rails 1 are composed of thin metal or other material, and the back end 7 comprises a flexible material such as cable or thin banding, wire or strap material. The side rails are mounted to a variable width face supported by handle 2, wherein the width 6 between opposing faces of the side rails may be adjusted by operation of controls 5, two representative locations of the controls being shown. This feature varies the space between the two sidebars. The operator's end is adjustable whereas at the back end of the bars a flexible material connects the two rigid bars in order to capture the product being moved. By adjustment of the width, the side rails can be moved to more closely conform to opposite sides of the products being faced, to help ensure that the products remain properly lined up with one another as they are pulled in the direction of arrow 3 for facing the products.

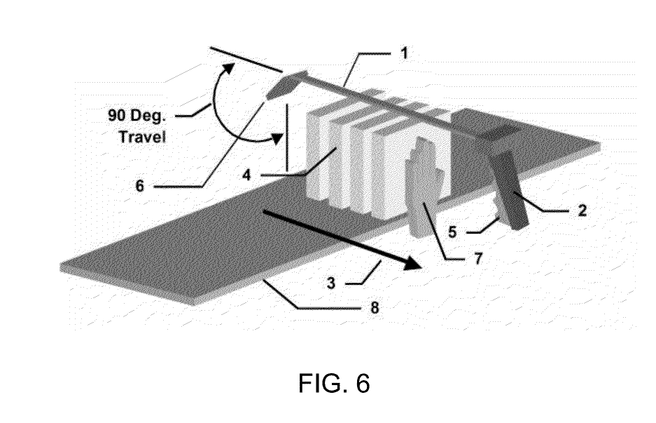

FIG. 6 is a perspective view of an alternative embodiment of a shelf facing device with an operable hook or tab, which is especially useful for facing rectangular objects. The device of FIG. 6 comprises a rigid tube 1 of metal or other strong material mounted to handle 2. A hook or tab 6 is mounted to the rearward end of the tube 1 and is operatively connected with a squeeze handle or trigger portion 5 of the handle 2 such that on operation of the trigger, tab 6 will rotate from a horizontal configuration to a vertical configuration. The tab remains in the “up” or horizontal position until the operator has reached into the back of the row of product. Once the operator has positioned the tab portion of the device behind the product or against the shelf back, the operator can activate the trigger to lower the tab into the “down” or perpendicular position, providing a rear face which may pull against the back face of the products 4. Also, the operator can place a hand 7, suitably the other hand that is not holding the handle 2, against the front face of the products 4 to steady the objects from tipping forward as the operator attempts to move the entire row forward on the shelf 8. Furthermore, the addition of this force to steady the product from toppling also provides a form of capture that prevents certain types or shapes of objects in the row from moving sideways. A curved hook or tab or other shape rather than a flat or straight piece can be utilized to better hold certain products from moving sideways, depending on the shape of the product being faced. A mechanism may be added to the shelf facing device to replace the operator's hand function. This can be provided in the form of a “tab” that moves from the front toward the back and presses against the product. Such a configuration would be for small items such as small boxes of bandages, spices or other items where a person might not conveniently reach back with a hand in the space provided.

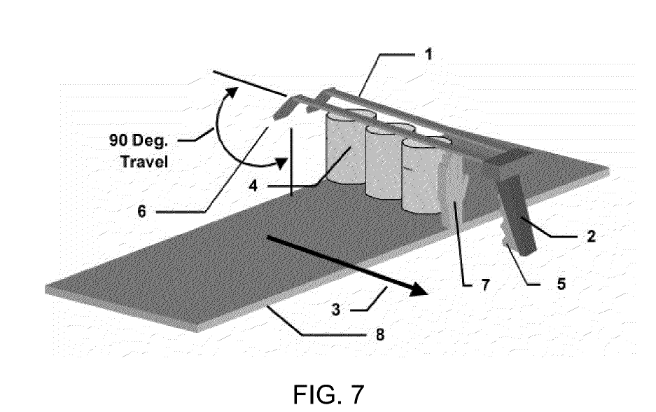

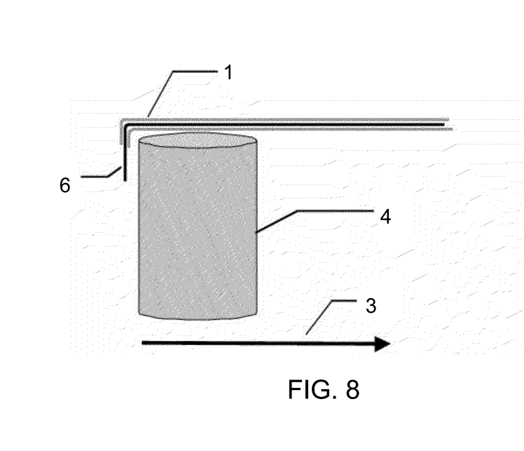

FIGS. 7 and 8 are a perspective view and side partial cut away view of an alternative embodiment of a shelf facing device with multiple hooks or tabs which is especially useful for round objects such as cans, but equally useful for rectangular objects. FIG. 7 shows how a second operable gripping device is added in parallel to the first to provide a wider surface area for gripping. Rigid member 1 (which may comprise a metal tube or other strong material) is attached to handle 2 which includes squeeze handle or trigger 5 which is operatively connected to tab or hook 6 mounted at the end of the member 1 opposite the handle. On operation of the squeeze handle, tab 6 rotates or travels 90 degrees (for example) from a substantially horizontal configuration to a vertical downward oriented configuration, providing a better method of capturing, and holding inline, cylindrical objects such as canned goods. This device might also be combined with the gripping material beneath the rigid bar as introduced in FIG. 4. The user might place a hand 7 against the front face of the products being faced while pulling the device in the direction 3 toward the forward face of the shelf 8. In addition, dual devices can be configured so that they are to be inserted along each side of the row of objects. In such a configuration, the hooks would be extended toward each other in order to capture a row of objects.

FIG. 8 illustrates an alternative method of devising an operable hook. The rigid bar is replaced with a rigid slot or tube 1 within which is a narrow strip of banding 6, which may be a movable wire or flexible flat metal/material. As the operator applies pressure upon the trigger handle, the banding 6 is extended from the slot opening into the fully extended position illustrated in FIG. 8 enabling the back face of product 4 to be engaged for moving in direction 3 toward the front face of the shelf.

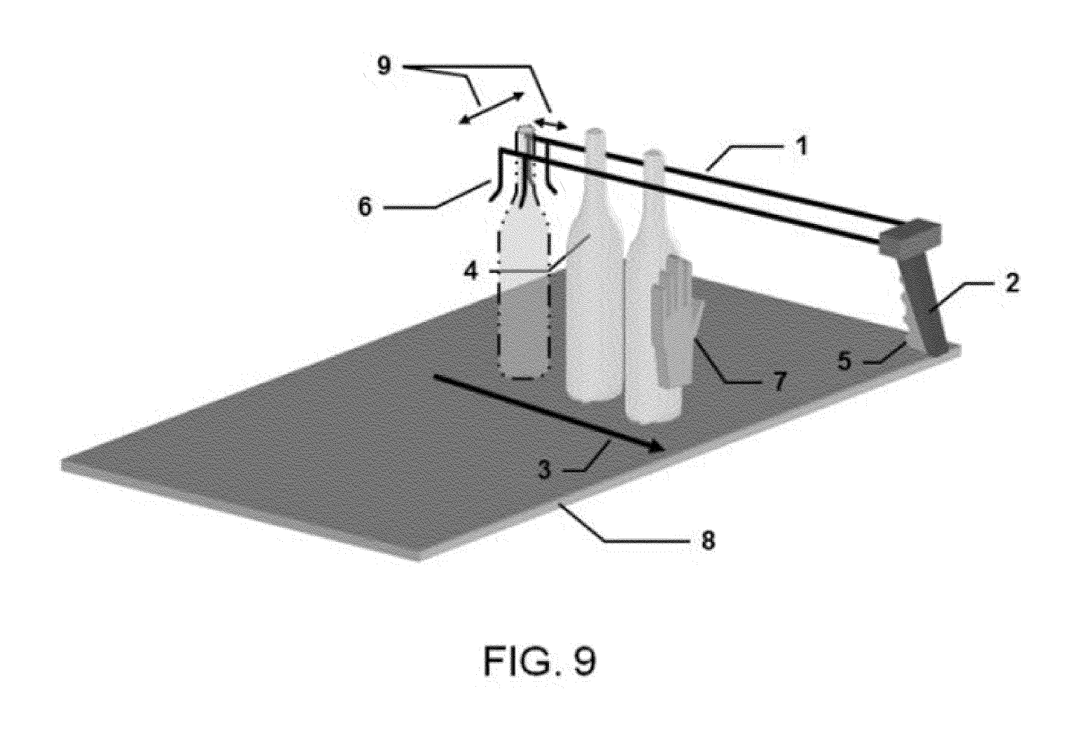

FIG. 9, a perspective view of an alternative embodiment of a shelf facing device, illustrates a different device particularly useful for bottles or product containers with a neck. This configuration employs a pair of rigid bars 1 (which may comprise tubes or rods) mounted to handle 2 incorporating trigger or squeeze actuator 5. At the ends of each of the rods distal from the handle are a pair of downwardly extending capture rods with a space between each individual finger on an individual pair, with an outwardly extending flare portion near the bottom of the fingers to approximately conform to the outward flare shape of a bottle neck. The two parallel rigid bars 1 are activated by the squeeze trigger to reduce the space between them. In the “open” position, the two side bars are spaced to easily pass between the adjacent rows of product. Additionally, they pass on either side of the bottlenecks. Once properly positioned near the rear-most bottle, the operator squeezes the handle trigger to close the device around the rear bottle thus capturing it in a way similar to that of a pair of tongs. As this occurs, the rods 1 line up on either side of the remaining bottles in that row, thus capturing those bottles from moving left or right. Then with the opposite (as opposed to the hand operating the handle) hand 7 placed as shown, the operator can move the entire row of bottles forward in the direction of arrow 3 on shelf 8. If there are any spaces between the bottles in the row, those will be taken up as the rear bottle is moved toward the hand positioned as shown. The direction of travel of the bars 1 is illustrated by arrows 9. Other methods of gripping the rear-most object can be utilized. However, the method utilizing the bars that close onto the remaining objects provides the alignment of those items as described.

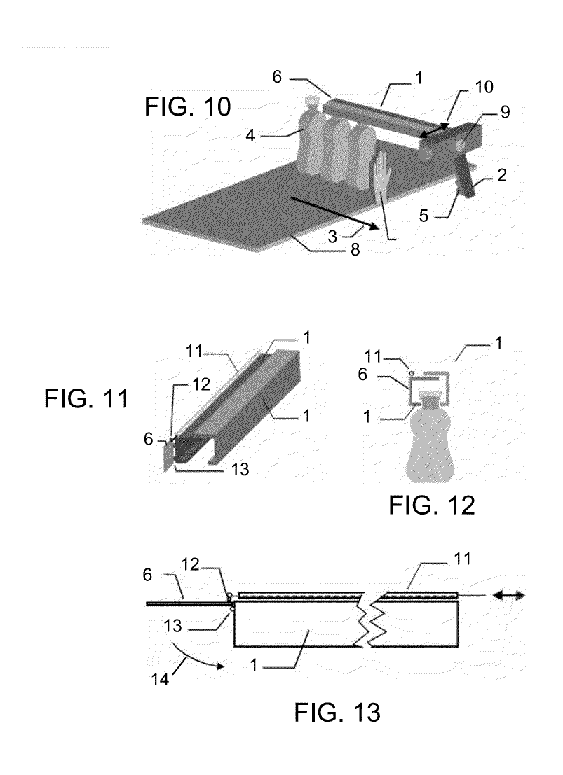

An alternative configuration to the device illustrated in FIG. 9 is shown in FIGS. 10 through 13. FIG. 10 is a perspective view of the alternative device having two rigid ell-shaped sidebars that are pulled together when activated by the operator, while FIGS. 11, 12 and 13 are perspective, end and side views illustrating the configuration of a flap or door, a tube containing a push/pull rod, and two sidebars of the device of FIG. 10. In this configuration, rigid side rails 1 mount to handle 2 which has a squeeze handle or trigger operation operative to vary the distance between left and right side portions of the two sidebars. A capture actuation cable 12 is carried in a capture cable rod or tube 11, extending from the trigger 5 to a capture door 6, hingedly attached at 13 to the distal end of one of the side rails to hinge horizontally or vertically. On actuation of the trigger 5, the capture door 13 closes the end of the opening between the two side rails, enabling engagement with the upper portion of the product being faced. The width of the opening between the two side rails is adjustable by operation of width control 9, to vary the opening between the rails in the directions of arrow 10.

FIG. 12 is a view illustrating the positioning and method of capturing objects having a cap area larger than the neck area using the device of FIG. 10.

This particular embodiment is more suited to objects that have a cap or cap-stop that is larger than the neck of the object. FIG. 10 illustrates the device being inserted over the row of objects 4 on shelf 8. Once in place, the two sidebars are closed tight together forming a channel and also straightening the row of objects. Additionally, the action contains the objects from moving sideways as illustrated in FIG. 12. Then the one (or more) fixed end or movable flap or door located at the end of the sidebar (or sidebars) is closed to contain the objects within the formed channel as the device is pulled toward the front of the shelf. The user can place hand 7 for controlling movement of the objects 4. FIGS. 11 through 13 illustrate how rigid ell shaped sidebars accommodate the larger cap area yet straighten the row of objects and prevent them from being lost as they are moved forward. FIGS. 11 and 13 also illustrate two methods of closing the end of the channel with a flap or door. More specifically, a operator activated push/pull rod closes or opens a door or flap that is hinged either from the side (FIG. 11) or from the top (FIG. 13) of a sidebar to swing in sideways or downward (in the direction of arrow 14 in FIG. 13) respectively. As alluded to earlier, the device can be configured with multiple doors and activated by the operator by means of multiple push/pull rods.

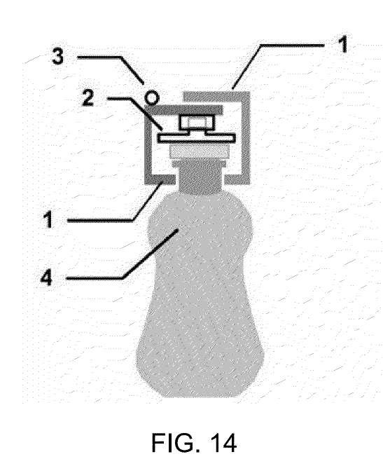

An alternative method to closing the end of the formed channel as illustrated in FIGS. 11 through 13 is illustrated in FIG. 14 and end view of a device for applying pressure onto the object cap area of the rearmost object in the row. This configuration employs two shaped rigid channel bars 1 of metal or other strong material and a gripping device 2 that presses downwardly on the cap of the object when actuated (for example by operation of a trigger handle) pressing the bottle for engagement between the gripping device and the lower ends of the channel formed by the two bars 1. Actuation is accomplished via a tube 3 extending along the bars 1, carrying a push rod or hydraulic fluid or air/pneumatic controls for actuation of the gripping device. Sufficient pressure from the gripping device 2 captures that object without damage to the cap area of the product. While FIG. 14 illustrates applying pressure to the top of the object, alternatively, pressure can be applied to one or both sides of the object.

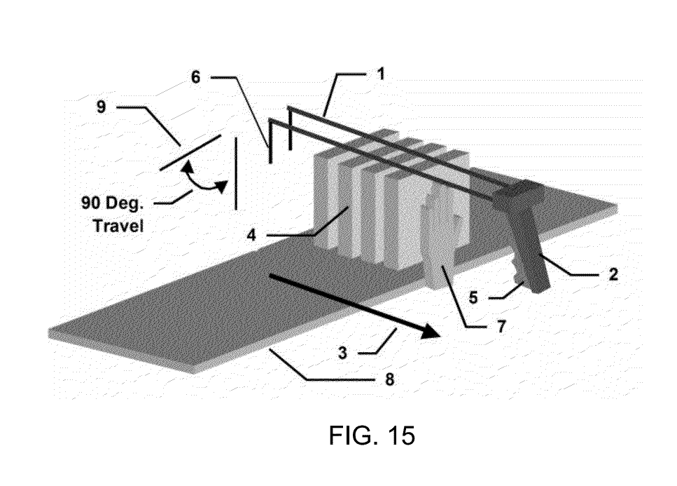

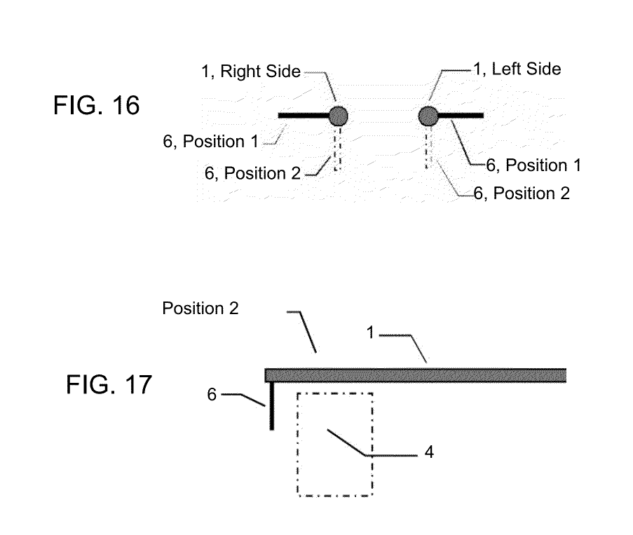

FIGS. 15 through 17 illustrate another form of the devices in perspective, back end and side views. The two parallel sidebars 1 of rigid thin material or rods are in the form of shafts, hex, round, square or something similar. Fixed at ninety degrees to the length of each shaft near the rear is a short gripping rod, finger or tab 6. The operator's trigger handle 2, 5 allows the long shafts to rotate along the arc illustrated at 9, suitably 90 degrees. FIG. 16 illustrates the two fully executed positions of rod(s) 6, identified as “position 1” and “position 2.” Position 1 allows the operator to insert the device over the product within minimal headroom. Once the device is inserted and positioned so that the short rods are behind the rearmost product, the operator rotates the shafts to position 2 as illustrated in FIG. 17. Once the short ell portions of the rods are behind the product in position 2, the operator can pull the product forward toward the front face of the shelf 8, again using a hand 7 to steady the products 4 if desired.

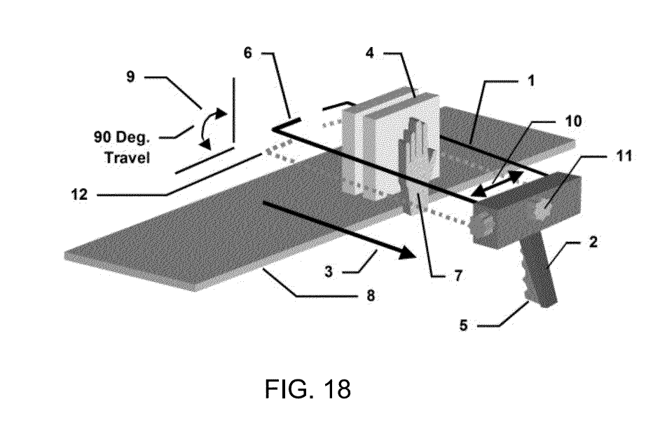

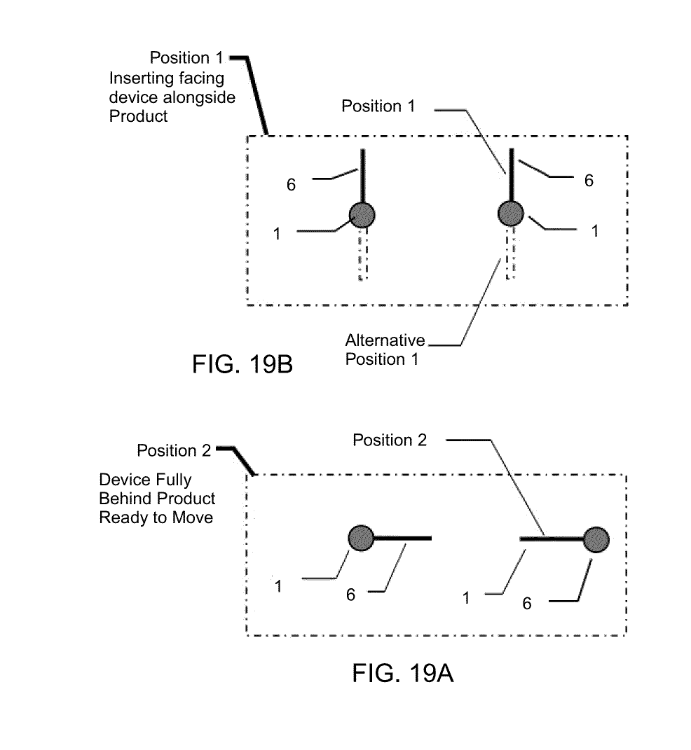

In addition to being configured for insertion into the space above the objects to be moved, the device may be configured so that the two sidebars are to be inserted along either side of the product. FIGS. 18, 19A and 19B illustrate such a device, FIG. 18 being a perspective view of the device and shelf, FIGS. 19A and 19B being an end view illustrating positions of gripping rods 6. In this configuration, rigid thin material or rods 1 are adjustably mounted to handle 2, with a width adjuster 11 allowing variation of the space between the 2 rods along line 10. Actuation of trigger handle 5 causes the end rods 6 to rotate along the arc 9 to move from vertically aligned to horizontal alignment, to allow capture of the rear face of the rear most product 4, allowing the products to be moved along the shelf in the direction 3 toward the shelf face, with the optional use of the user's hand to steady the product. The adjustable width allows use with various width objects. Since the rotating shafts are not limited to minimal space as is often found in the headroom above the objects, the device can be equipped with more than one pair of rotating shafts. The additional set(s) 12 of rotating shafts will then be mounted directly above or below the first set. There are two possible initial positions for the rotating shafts as they are inserted where the short shaft or ell is pointed up or down. After insertion, the shafts are rotated so that the short part of each ell is pointing toward the object to be moved.

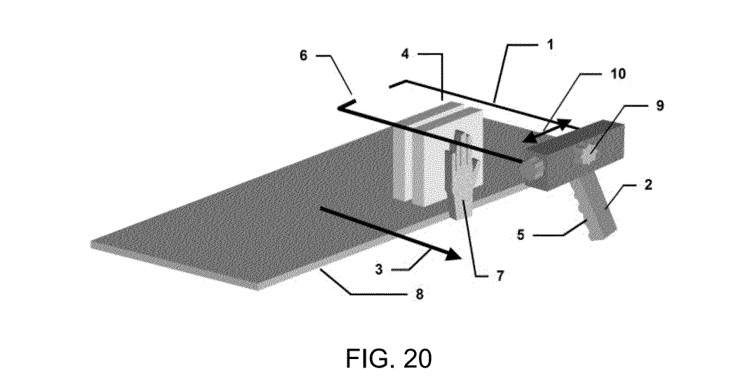

FIG. 20 is a perspective view that illustrates a variation of the device illustrated in FIG. 18 where the end hooks 6 on the rigid side bars 1 are fixed in the inwardly bent positions. In a corresponding way to with the device shown in FIG. 5, the device is be inserted within the headroom space above the objects to be moved. Once the hooks 6 are placed behind the last object in the row, the device is lowered to an optimal location and the objects 4 are captured and moved forward by the operator in the direction of arrow 3 to move toward the face of shelf 8. Again, optional use of hand 7 to support the objects 4 may be employed. The distance between the 2 side bars may be adjusted in the direction of arrow 10 by width adjuster 9. No trigger/actuator is provided on handle 2, although in another version another control 5 can be added to bring the two sidebars together for the purpose of gripping the entire row or to align a row of objects. This type of gripping/alignment control can be added to many of the devices described above.

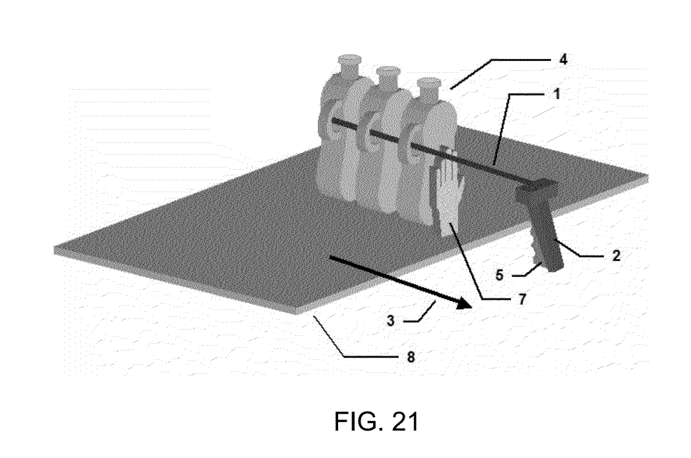

A different form of shelf facing device is illustrated in FIG. 21, perspective view of a specifically designed device for moving objects having a loop-shaped handle. A rigid tube or shaft 1 is mounted to handle 2 and is inserted through all of the handles of the objects 4 in the row on shelf 8. Once fully inserted and positioned with the end of the tube adjacent to the handle of the last object in the row, the operator activates the device trigger or squeeze handle 5 to grip that rearmost object. The operator then moves the gripped object forward in the direction of arrow 3 toward the front of the shelf, moving other more frontward objects as they stack against the gripped object. The objects not gripped are also captured to some degree from moving sideways due to the tube placed through the handles. The operator's second hand 7 may be placed against the forward-most object to steady the row as it is moved forward toward the shelf face.

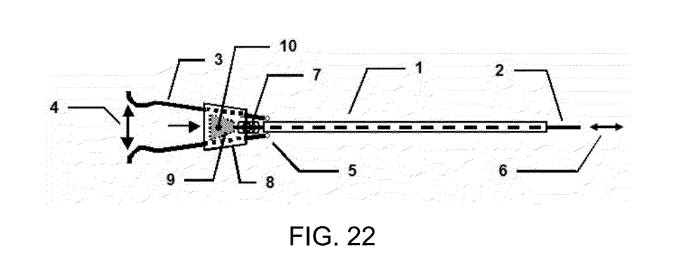

A variety of methods might be employed to activate the expanding grippers on the end of the rigid tube. One method is illustrated in FIG. 22, a top view illustrating a gripping device located at the end of the facing device depicted in FIG. 21. Rigid tube 1 carries an activation rod or cable that is actuated by the trigger/grip on the operator's handle, for activation of a gripper at the end of the tube. Grippers 3, which can comprise rods or hooks, are attached at 5 one end near the end of the tube while the other end of the grippers is left unattached. A wedge or cone shaped spreader 9 is mounted in a cone shaped retaining ring/collar 8 and an activation rod 2 moves the collar is moved toward the attached end to push the grippers outward. An activation rod or cable is connected to the cone and to the operator's control. The retaining ring/collar 8 keeps the grippers from moving outward beyond the intended distance. The spreader 9 is attached to the retaining ring so that both the spreader and ring move together. Movement of rod 2 causes the ring/collar/spreader to move to spread the grippers 3 outwardly or inwardly in the direction of arrow 4. Spring members 7 urge the grippers toward a closed position in absence of actuation of rod 2. Thus, a control is maintained over the grippers in both inward and outward directions. Upon release by the operator, a return spring pushes the spreader cone back and the grippers close again to deactivate the grip.

A return spring can be employed as an alternative to the retaining ring. Besides this substitution, rubber pads can replace the hooks shown in FIG. 22. Electronic activation and powered hydraulic pumping can also replace the mechanical design illustrated. Electrical or electronic controls can replace the hand activation in this device to reduce stress upon hand and forearm joints and ligaments that might be due to extended daily use. Likewise, hydraulic controls can be added with or without electrical control. Such variety of controls may be applied as well to all of the devices described above where applicable.

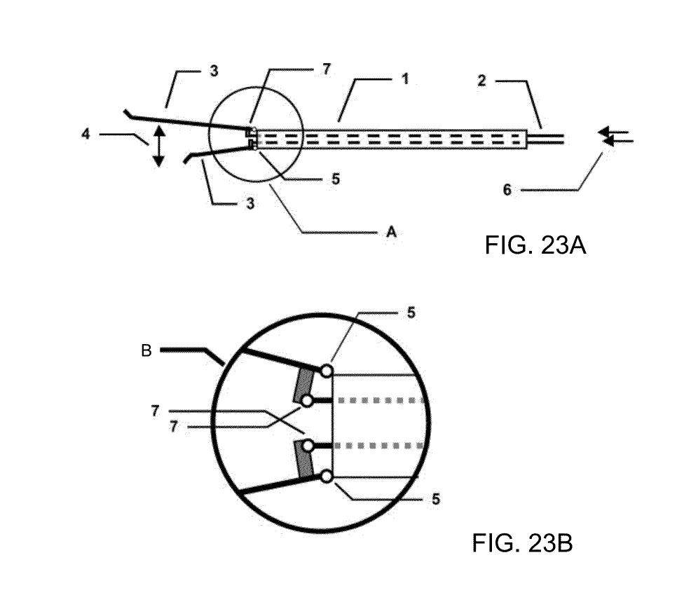

An alternative design to the gripper system illustrated in FIG. 22 is shown in FIG. 23A and FIG. 23B. This design is especially adaptable to a hydraulic activation method where a lot of force may be applied to a short travel distance. Multiple grippers or tabs 3 are mounted to the end of rod 1 at pivot points 5, connected to actuation rod 2 via pivot connectors 7. Movement of rod 2 along arrow 6 causes the grippers rods or hooks 3 (which may have soft pads mounted thereto for improved gripping) move inwardly and outwardly of each other along arrow 4. The movement of the grippers outwardly from each other causes them to wrap behind the handle of the object or the object itself. Two tabs are illustrated, one short and one long. The shorter of the two can wrap behind the handle only without touching the adjacent row of objects. The longer tab can wrap behind the object so that the object is held stable when pulled forward. “Push” rods are utilized rather than “pull” cables which also may be utilized. The magnified view area shown in FIG. 23A illustrates a method of attaching the push rods to the tabs. Hydraulic cylinders push/pull the push rods from the operator's end of the push rod. As with the devices above, an electrical type of activation may be substituted for the hydraulic activation method.

Hydraulic activation of the hooks or grippers for the device illustrated in FIGS. 21 through 23A and 23B can improve the effect of applying equal pressure to all of the grippers regardless of travel distance. Additionally, hydraulic activation can be applied to many of the devices for improved control and miniaturization of the device moving parts.

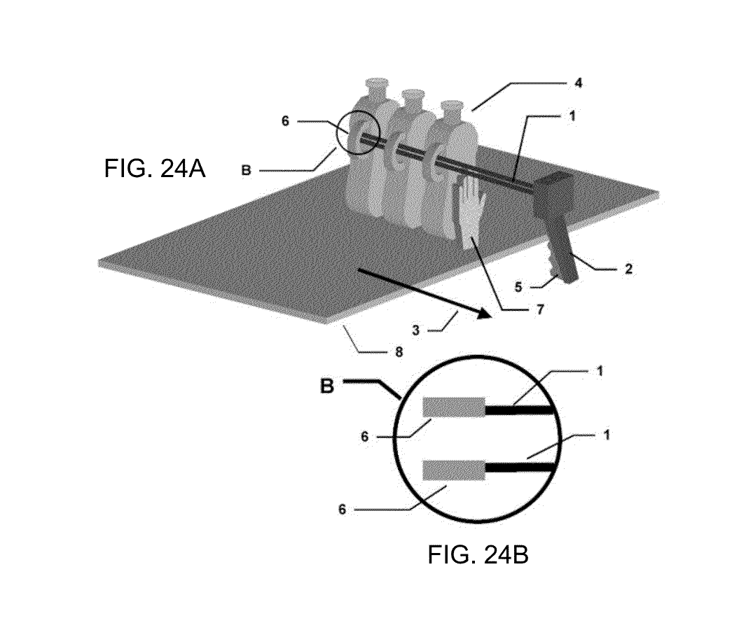

Another design of configuration corresponding to that illustrated in FIG. 9 only reversed is also useful in gripping objects having a loop-shaped handle. Rather than grip as one would with a pair of tongs, the grip is accomplished by moving a pair, or multiple rods, apart with a degree of force sufficient to grip the rearmost object in the row. FIGS. 24A and 24B are perspective views that illustrate such a device. As with the device shown in FIG. 9, the ends of the gripper rods 6 can be adapted with hooks, rubber pads (as represented in magnified view area of FIG. 24B), or other forms of design that will grip the object better than with a smooth rod end. Since the objective of this device is to insert through the loop of the object's handles, the rods 1 can be parallel when in the insert position or they can be slightly crossed to better accommodate the particular rod ends affixed. The rods 1 shown in FIGS. 24A and 24B are parallel and mounted vertically to each other. However, they can be mounted horizontally or on an infinite array of degrees in between. As with other configurations, actuation of trigger/grip 5 on handle 2 causes the rods 1 to spread apart from each other, grasping the handle of the rearmost object 4 to allow the objects to be pulled in direction 3 toward the face of shelf 8, with optional use of the user's hand 7.

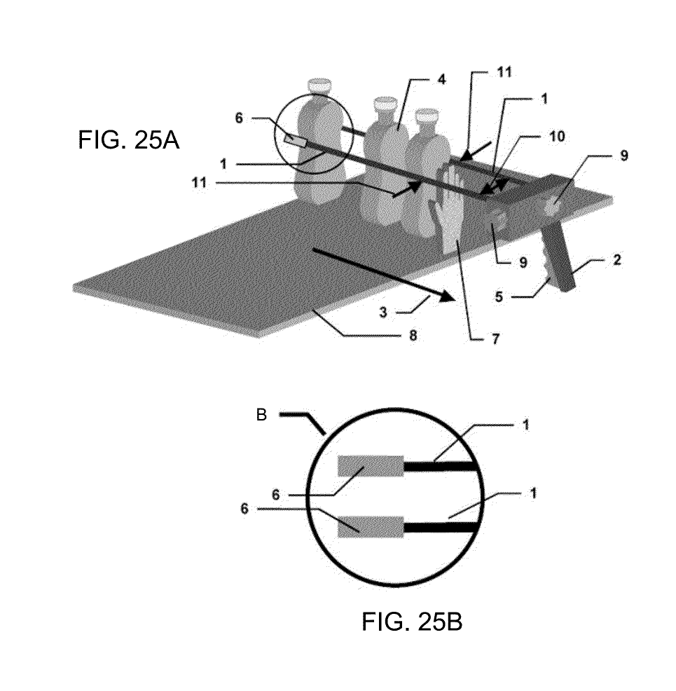

FIG. 25A is a perspective view that illustrates yet another alternative configuration to the devices illustrated in FIGS. 9 and 24A, 24B. Here, the elongate rods 1 can have the width therebetween varied in the direction of arrow 10 by operation of adjusters 9 carried on handle 2. Activation of the handle trigger/grip 5 causes the two rods 1 to move inwardly toward each other in the direction of arrows 11, gripping at least the rearmost product 4 so that the products can be pulled in direction 3 on the shelf 8, with the optional use of hand 7 for steadying the products. In addition, the rods can move with significant force inward (or outward) to grip objects of a variety of shapes. Such a device can be a universal replacement for devices illustrated in both FIG. 9 and FIG. 24A, 24B. End grips can be composed of a variety of materials or shapes. A soft rubberized material 6 is represented in the magnified view area in FIG. 25B.

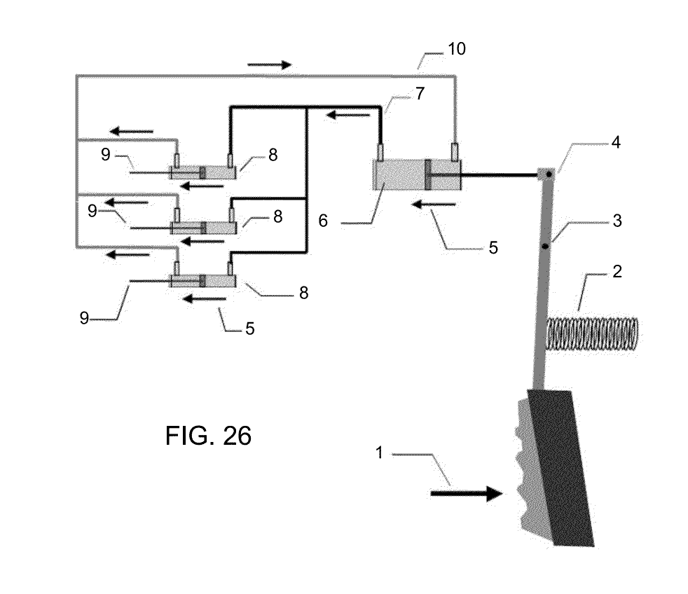

FIG. 26 is a hydraulic control diagram of a form of closed loop hydraulic control for a facing device. a form of control in which the force applied to the master cylinder moves the gripper cylinders. Arrows show the direction of mechanical and fluid flows. Once released, the flow is reversed due to the pressure applied by the return spring and the gripper cylinders return. All directional arrows shown would be reversed to indicate reverse flow.

In FIG. 26, force 1 is applied by actuation of the trigger handle. Return spring causes the handle to return to a non-activated position on removal of actuation force. Movement about the pivot point 3 causes connecting and pivot point 4 to cause movement of piston 5 in the direction of the arrow, operating master cylinder 6 to transfer hydraulic fluid through forward direction hydraulic line 7, operating the gripper activation cylinders 8, causing movement of the pistons in direction of arrow 5, extending activating piston shafts 9 to operate grippers connected thereto. Return hydraulic line 10 completes the circuit. It is to be understood that pneumatic control and activation may be substituted for hydraulic means and that powered assist may be employed.

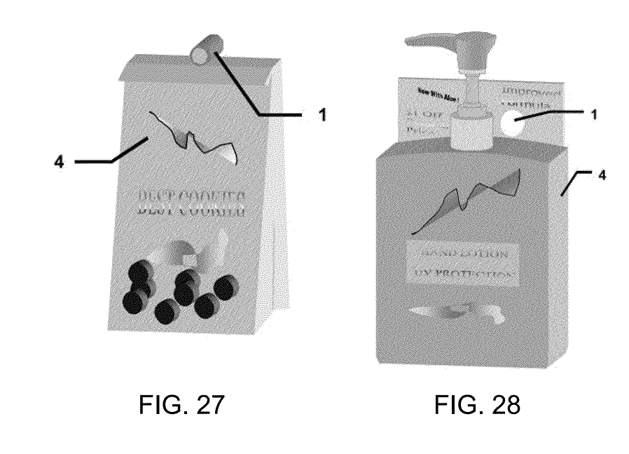

Many objects do not have shapes or attributes readily acceptable to the concept of movement by a facing device. Such objects can be redesigned by manufacturers to accept facing device capture. Furthermore, certain objects can be made more accommodating to capture by the application of economical objects affixed to the containers themselves. Certain types of devices can also be added by the retailer and removed at the point of sale as security devices are often utilized, particularly in the clothing market. Moreover, security devices can be designed with the concept of dual purpose, security and better shelf facing. FIGS. 27 through 31 introduce the concept by illustrating a variety of example designs intended to make objects more practically movable by shelf facing devices, by providing the objects or their containers/packaging with features adapted for engagement with a shelf facing tool.

FIG. 27 illustrates a small tubular shaped object 1 that is affixed to a package. In this case a paper sack type of container object 4 is illustrated. The tube is to be composed of a lightweight, economical material such as paper or plastic. Two types of facing devices might be utilized to capture a row of objects equipped with tubes as shown. Either a facing device can be inserted through the tube 1 positioned on the object or a facing device can be utilized to clamp the tubes from the outside.

FIG. 28 illustrates a bottle 4 with a cardstock affixed. The cardstock is made with one or more cutouts 1 so that a row of bottles is captured when a facing device is inserted through the cutouts.

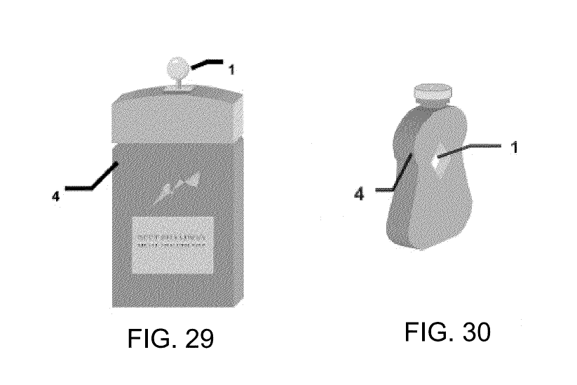

FIG. 29 illustrates an example capture design object with spherical shape. The object 1 is to be captured by clamping from the sides. Such an object can be affixed to the container 4 as shown or can be molded into the container design with or without a “break off” feature to enable easy removal by consumer. In the example shown, the container is a bottle similar to many currently on the market but with the sphere or ball configuration capture object attached to the large cap.

FIG. 30 illustrates an example of how a container 4 might be specifically designed to accommodate the implementation of a facing device. In the case of FIG. 30, the bottle 4 shown is designed with a hole 1 at the center, not for style in this illustration but to accommodate a facing device. However, eye appealing designs can be made around the concept of making the container easy to capture by the facing device.

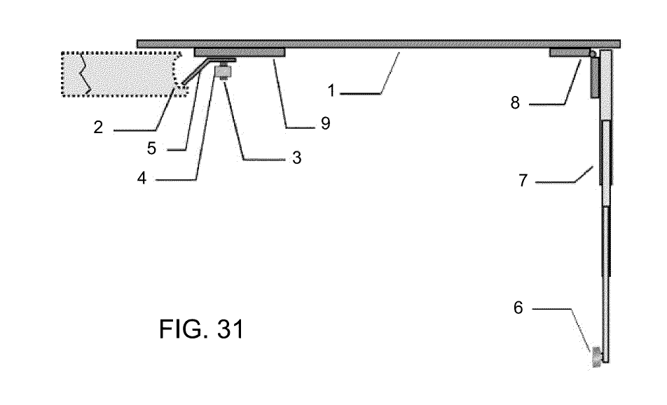

On occasions when the seller is seeking to rotate the stock so that older stock is sold first a modification of the facing process is required. In cases where the product to be moved is light-weight such as with breakfast cereal boxes, the product can be captured with the shelf facing device and set aside while newer product is place on the shelf at the back of the row. Then the older product can be replaced by utilizing the facing device. However, some products are not so easily removed. Thus, another element may be required in order to efficiently utilize the shelf facing device. There is a need for an easily accessible place to temporarily store older product while newer product is inserted at the back of the row. FIGS. 31 through 33 illustrate variations of shelf extension devices and how they may be utilized in the process. This type device creates a temporary location onto which the goods existing on the shelf are moved forward out of the work area and stored momentarily while newer product is inserted toward the back of the shelf. The facing device is first utilized to move the older goods forward onto the shelf extension. Once the new stock is placed onto the shelf, the facing device is utilized to reposition the older stock at the front of the row.

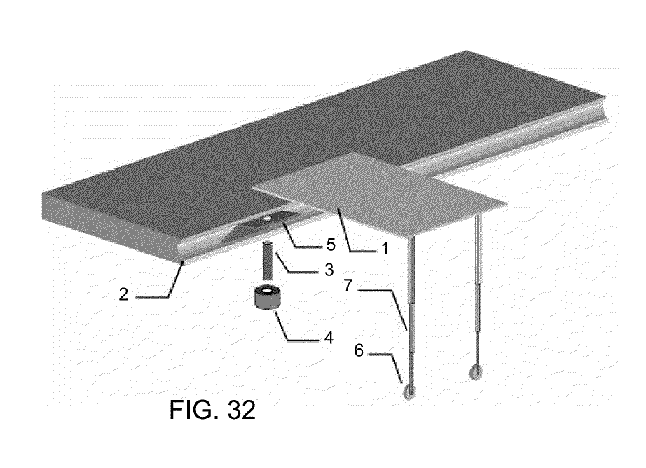

Referring to FIG. 31, a side view and FIG. 32, an assembly view, shelf extension 1 is adapted to rest on shelf 2, which may be fitted with a label channel or track for product labeling. A bolt 3 mounts via attachment plate 9 a shelf clip 5 which is adapted to fit within the shelf label track. A hand tightening wheel 4 allows the shelf clip to be tightened in position for assisting to hold the shelf extension in position. The end of the shelf extension most distal from the shelf mounts an extendable leg 7 via optional position lockable hinge mount 8 for foldable storage of the leg against the shelf extension, with an optional caster 6 for easy rolling of the shelf extension when in use.

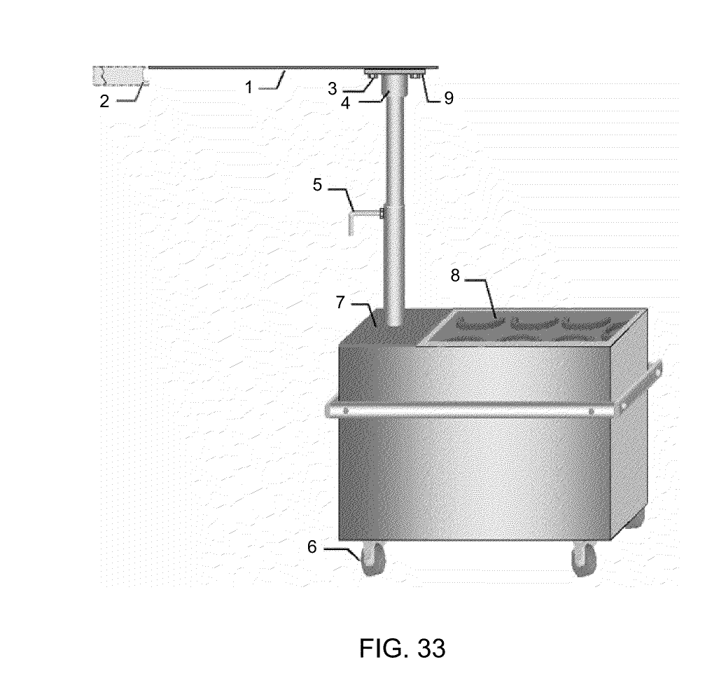

FIG. 33 is a perspective view of a cart 7 for multiple shelf facing device storage with integrated shelf extension device, wherein the shelf extension 1 is bolted via bolts 3 and mounting plate 9 to an adjustable height swivel base 4. The height of the shelf extension is adjustable by control 5. The cart includes multiple storage positions 8 to hold one or more facing devices. The cart is mounted on casters 6 for easy movement and can carry different configurations of the facing devices to enable a user to select the most appropriate facing device for the specific product type being faced.

Such a temporary shelf can be replaced by a powered belt conveyor with forward and reverse travel. Travel may then be controlled by the operator and at variable speeds to remove and replace product while fresher product is loaded at the back of the shelf.

Thus, in accordance with the disclosure, plural facing devices and associated shelf extensions are provided, for improved product facing.

While a preferred embodiment of the technology has been shown and described, it will be apparent to those skilled in the art that many changes and modifications may be made without departing from the broader aspects. The appended claims are therefore intended to cover all such changes and modifications as fall within the true spirit and scope of the technology.

1. A device for facing shelves, comprising:
an elongate member for extending towards a back of a shelf to reach beyond a back face of an item on the shelf; and
an engager for interacting with the item on the shelf to enable pulling of the item towards a front face of the shelf.

2. The device according to claim 1, wherein said elongate member comprises a hoop shaped member adapted to fit over the top of the item on the shelf and said engager comprises a rear-most portion of said hoop shaped member.

3. The device according to claim 2, wherein non-rear-most portions of said hoop shaped member are substantially rigid.

4. The device according to claim 1, wherein said elongate member comprises first and second rigid sidebars adapted to reach over a top portion of the item on the shelf for positioning said engager behind the item on the shelf.

5. The device according to claim 1, wherein said engager comprises a rotatable member adapted for movement between an engaging position and a non-engaging position.

6. The device according to claim 1, wherein said engager comprises plural selectable engagement members, enabling selection of an individual one of said plural selectable engagement members depending on the configuration of the item on the shelf.

7. The device according to claim 1, wherein said elongate member comprises a portion providing frictional engagement with the item.

8. The device according to claim 1, wherein said elongate member comprises first and second side bars laterally spaced apart from one another and adapted for positioning along first and second sides of the item.

9. The device according to claim 8, wherein the lateral spacing between said first and second side bars is adjustable to accommodate narrower or wider items.

10. The device according to claim 9, wherein an adjustment member allows varying of the spacing between said first and second side bars.

11. The device according to claim 1, wherein said elongate member comprises a first member adapted for passing through a handle portion of the item.

12. The device according to claim 11, wherein said elongate member comprises a second member adapted for passing through the handle portion of the item, and said engager comprises a mechanism for increasing a distance between said first and second members so that the first and second members interact interior surfaces of the handle portion to grip the item.

13. The device according to claim 1, wherein said engager comprises an ell-hook member.

14. The device according to claim 13, wherein said ell-hook member is movable between an engaging position and a non-engaging position.

15. The device according to claim 1, wherein said elongate member comprises a tube and said engager comprises a controllable gripper adapted to selectively grip the item.

16. The device according to claim 1, wherein said elongate member comprises plural ell-shaped members adapted for placement along opposing sides of a neck member of the item and said engager comprises a door member for closing a rear open space between said plural ell-shaped members for keeping the item contained between said ell-shaped members.

17. The device according to claim 1, wherein said elongate member comprises plural members adapted for movement towards said item for containment of said item within an area, enabling alignment of said item with other ones of items on the shelf.

18. A product or product container, wherein said product or product container comprises one or more features adapted for engagement with/by a shelf facing device.

19. The product or product container according to claim 18, wherein said one or more features comprise an engagement object that is adapted to be affixable to said product or defined within said product container.

20. The device according to claim 1, further comprising a frictional engager for frictionally engaging the item for assisting movement of the item.

21. A method for facing a shelf comprising the steps of:
extending the elongate member of the device of claim 1 relative to one or more items on the shelf so that the engager is positioned to engage at least one item on the shelf; and
pulling the device forwardly while engaging the at least one item with the engager.

22. The method according to claim 21, further comprising the steps of adjusting the engager to more closely conform to opposite sides of the one or more items.

23. The method according to claim 21, further comprising the steps of adjusting the engager to operate a movable portion of the engager to move to an engagement position so as to engage a portion of the at least one item.

24. The method according to claim 23, wherein said adjusting comprises moving an item rear portion engaging arm to an engaging position.

25. The method according to claim 21 further comprising providing alignment members and engaging plural ones of said at least one item for assisting in aligning plural ones of said at least one item in a row or other configuration.

26. The method according to claim 25, wherein said providing alignment members comprises providing spaced parallel members for positioning on opposite sides of the plural ones of said at least one item and moving said spaced parallel members closer together to urge said plural ones into alignment.

27. The method according to claim 21, further comprising said engager providing a downward pressure on the at least one item when engaging the item.

28. The method according to claim 21, further comprising engaging said engager by rotation of a portion thereof into an engagement position.

29. The method according to claim 21, further comprising said engager employing a feature engager function for engaging a particular configuration feature of the at least one item.

30. The method according to claim 21, further comprising activating said engager by use of hydraulic activation.

31. The method according to claim 21, further comprising activating said engager by use of electrical control.

32. The method according to claim 21, further comprising activating said engager by use of pneumatic activation.

33. A method of facing plural items on a shelf, comprising:
extending an item engager along at least one side of said items toward a rear portion of the shelf;
engaging said at least a rearmost one of said plural items; and
using said engager and its interaction with the items to face the items.
